(19) United States
(12) Patent Application Publication
(10) Pub. No.: US 2012/0086550 A1
(43) Pub. Date: Apr. 12, 2012

(54) PEDOBAROGRAPHIC BIOMETRIC SYSTEM

(76) Inventors: Donald Joseph LeBlanc, Nepean (CA); Julia Petruescu, Gloucester (CA); Paul A. Bennett, Nepean (CA)

(21) Appl. No.: 13/202,967

(22) PCT Filed: Feb. 18, 2010
(86) PCT No.: PCT/CA10/00223

§ 371 Date: Dec. 23, 2011

Related U.S. Application Data
(60) Provisional application No. 61/155,076, filed on Feb. 24, 2009.

(30) Foreign Application Priority Data
Apr. 9, 2009 (CA) 2,662,431

(51) Int. Cl. G06F 7/04; G06F 19/00

(52) U.S. Cl. 340/5.82; 702/19

(57) ABSTRACT

A method and system to characterize the wearer of at least one item of footwear having a sensor means which, while the item is being worn, collects from the wearer current pedobarometric data that is characteristic of the wearer, and the current pedobarometric data is compared with corresponding reference data for a specified wearer, preferably previously collected via the same or a similar item of footwear while worn by the specified wearer under controlled conditions, the results of the comparison being used to characterize the present wearer according to prescribed criteria.

### TECHNICAL FIELD

This invention relates to systems and methods for authenticating, authorizing, identifying or otherwise characterizing a person by biometric means. The invention also relates to a system and method for linking items of apparel forming a set.

### BACKGROUND

In the context of this patent specification, the word “characterizing”, as in “characterizing by biometric means”, means to distinguish the person on the basis of biometric characteristics peculiar to that person, whether for authentication, authorization, identification or other purposes.

Generally, security and privacy authentication/identification systems have the objective of allowing authorized individuals to have access to something, while denying access to unauthorized individuals. Such known systems typically require the authorized individual to have a key, which may be a traditional key for a tumbler lock or, more recently, a card or badge with a magnetic strip, a radio frequency identification (RFID) tag and even a password for electronic systems. Such key-based systems are vulnerable because an unauthorized individual might obtain a key illicitly.

This limitation has been addressed by replacing or supplementing the key with biometric data unique to the authorized individual or group of individuals. Some types of biometric data require relatively invasive acquisition, such as testing for DNA which requires biological samples to be taken from the individual being authenticated/identified. Some are relatively non-invasive, such as retinal scans or fingerprints, but require contact or close proximity, which may be undesirable. The same applies to identification bracelets storing biometric information, such as facial images, which have been proposed for use in identifying airplane passengers. Others, such as video gait analysis, require special conditions including external database access and complex processing.

Generally, known biometric authentication/identification systems share a limitation that has been carried over from the simpler electronic key security systems in that they rely on some form of external database of biometric data from multiple authorized/specified individuals against which to compare the biometric data newly-acquired from an individual being authenticated/identified. How the comparison is made differs. An authentication or verification system performs a one-to-one comparison between the newly-acquired biometric data of the subject person and the previously-stored biometric data for the specified enrolled individual, i.e., compares it with a single template. Based upon the comparison, the authentication or verification system then either accepts or rejects the subject person's claim to be the specified individual as TRUE or FALSE. Of course, it is possible for a person to be authenticated without the person's identity being determined.

An identification system, however, performs a one-to-many comparison, comparing the instant biometric data with previously-stored biometric data or templates for many enrolled individuals until a match is found. Based upon this comparison, the identification system either identifies or fails to identify the subject person as a particular one of the many enrolled individuals, i.e., answering the question “Who is this?” In this case, the system establishes the individual's identity without the individual having claimed to be a specific enrolled person.

In general, therefore, such known biometric authentication/identification systems employ a central computer database storing the biometric data of many individuals and one or more readers which acquire biometric data from the individual whose identity is to be determined, or who is to be authenticated, and communicate the data to the central computer database for comparison with the stored biometric data. These systems may be adequate in many situations, but may not work well in remote areas where database access may be limited or unavailable. Moreover, it may be desirable to authenticate/identify an individual from a distance in case the individual is a potential assailant, for example someone seeking access or proximity to an authorized establishment or person by wearing a uniform normally worn by authorized members of a uniformed civilian or military group.

### SUMMARY OF INVENTION

An object of the present invention is to overcome or at least mitigate deficiencies of such known systems, or at least provide an alternative, and, to this end, aspects of the present invention comprise a method and system wherein at least one item of apparel has sensor means which, while the item is being worn, collects from the wearer current biometric data, preferably pedobarometric data, that is characteristic of the wearer, and the current biometric data is compared with corresponding reference biometric data for a specified wearer, preferably previously collected via the same or a similar item of apparel while worn by the specified wearer under controlled conditions, the results of the comparison being used to characterize the present wearer according to prescribed criteria.

The characterizing step may determine whether or not the current wearer is the specified wearer. Additionally or alternatively, the characterizing step may identify the wearer.

Preferably, the reference biometric data is stored locally, i.e., in a storage device in or associated with the item of apparel.

At least initially the reference biometric data comprises data that is acquired during what may conveniently be termed a registration or “enrollment phase”, during which the specified wearer wears the at least one item of apparel under controlled conditions to establish initial reference biometric data for the specified wearer. In effect, this “stamps” the item with the specified wearer's biometric “signature”. Subsequently, the sensor means captures new biometric data and processing means in or associated with the item of apparel compares the newly-acquired biometric data with the reference biometric reference data and characterizes the wearer in dependence upon the result of the comparison. This may conveniently be designated a characterization phase comprising authentication and/or identification phase.

The biometric data collected from the sensor means may be processed to produce a template, the comparison of the reference biometric data and the newly-acquired biometric data being performed by comparing their respective templates. In preferred embodiments, each of the templates comprises a mean matrix and a correlation vector.

If desired, more than one reference template may be produced and stored; for example one template for the specified person carrying nothing, a second template for the person carrying, for example, standard-issue weapons and/or gear, a third template for the person carrying a standard backpack, and so on.

In preferred embodiments, the processor means causes the sensor means to acquire the biometric data whenever the item of apparel has been doffed and donned again and, if desired, at predetermined intervals while the apparel is being worn. Newly-acquired biometric data may be used to update the reference biometric data, the updated reference biometric data being used for subsequent characterization steps/phases. Preferably, however, the initial reference biometric data, or at least the template derived therefrom, would be retained as a default in case, for example, the updated data became corrupted.

If the comparison with the reference biometric data indicates that the newly-acquired biometric data and the reference biometric data differ by at least a predetermined amount, the processor means outputs a signal indicating that the item of apparel (at least probably) is being worn by someone other than the specified wearer.

Preferably, when the processor means has determined that the wearer is not the specified wearer, the signal indicating that the wearer is not the specified wearer is provided by an annunciator means which may be passive, for example a wireless transponder, or active, for example a visual display which may be located on the item of apparel itself or on another item usually worn or carried by the specified wearer. The signal may be covert, so that the wearer is not aware that it has been determined that s(he) is not the specified wearer.

If the comparison between the newly-acquired biometric data and the previously-stored biometric data leads to a conclusion that the wearer is indeed the specified wearer, the newly-acquired biometric data may be used to update the stored biometric data.

In preferred embodiments of one aspect of the invention, the at least one item of apparel, e.g., footwear, clothing, headgear, and so on, is of a kind worn only by a restricted group of people, for example is a part of a uniform worn by military, law enforcement, utility personnel or the like whose uniform identifies the wearer as a member of the group.

Where the item of apparel having the sensor means is one of a set of items of apparel, for example a uniform, that would usually be worn together, each item may have means for registering that item as part of that set and means for detecting whether or not all items in the set are being worn together. In preferred embodiments having annunciation means, the latter may signal an unauthorized wearer based upon the biometric data comparison and/or a mismatch in the set of items of apparel. The initial registration process then may also register all items of the set apparel issued to the specified wearer.

The microprocessors and data storage (memory) for the system preferably are disposed on or in the item of apparel itself. For example, if the item of apparel is an item of footwear, such as a boot or shoe, they may be housed in a heel thereof.

Preferably, the at least one item of apparel comprises a footwear item and the biometric data is pedobarographic data, preferably kinematic data acquired from the footwear during normal activities. Conveniently, the biometric data may be acquired in real time through one or more pressure sensitive pads positioned underneath the feet during normal walking or, possibly, standing.

In preferred embodiments using pedobarographic data, during the data acquisition phase, the pedobarographic biometric characteristics of the individual are first scanned by a biometric reader to produce a raw digital representation of the relevant characteristics of their motion. Preferably, a quality check will be performed to ensure the quality of the captured data. Using suitable algorithms, the raw digital representation is processed to generate a template. The template is stored, preferably in an encrypted fashion, in a central database in the storage device of the biometric system. The storage device may be housed in the footwear, along with the processor and other parts of the system.

According to another aspect of the present invention, there is provided a system characterizing a wearer of an item of apparel, the system comprising sensor means in or associated with the item for sensing at least one biometric characteristic of a wearer of the item, storage means in or associated with said item for storing biometric data, and processor means for controlling the sensor means to acquire biometric data from the wearer, compare the acquired biometric data with corresponding biometric data for a specified wearer, preferably previously collected via the same or a similar item of apparel while worn by the specified wearer under controlled conditions, characterizing the wearer in dependence upon the results of the comparison according to prescribed criteria, and for outputting a signal indicative of the result of the characterization.

The processor may characterize the wearer by determining whether or not the current wearer is the specified wearer. Additionally or alternatively, the processor means may characterize the wearer by determining the identity of the wearer.

In preferred embodiments of this aspect of the invention, during an initialization or enrollment phase the processor means processes the acquired biometric data to create a reference biometric template or signature for that wearer and saves the reference biometric template in said storage means. Subsequently, and especially when the item of apparel has been doffed and donned again, the processor acquires via the sensor means new biometric data from the wearer, compares the newly-acquired biometric data with the stored biometric data and characterizes the wearer in dependence upon the comparison.

If differences between the stored biometric data and newly-acquired biometric data exceed prescribed limits, the processor means will determine that the wearer does not have the required biometric characteristic, for example, because the apparel is being worn by a person other than the specified wearer, and provide an indication to that effect.

Conversely, if the processor determines that the current wearer is the specified wearer, the processor may use the newly-acquired biometric data to update the stored biometric data, or at least the template, where applicable, and compare subsequently-acquired biometric data with the updated stored biometric data/template. The processor may retain the original biometric date or template as a default.

According to another aspect of the present invention, there is provided a method for identification of an alarming event comprising: monitoring pedobarographic sensor means to obtain pedobarographic biometric data of at least one individual; generating a current pedobarographic template for each individual from said pedobarographic data; determining a degree of correlation between a current pedobarographic template and a plurality of stored reference pedobarographic templates that were generated under alarming conditions, by comparing the current pedobarographic template with the plurality of stored reference pedobarographic templates that represent alarming conditions for each individual; wherein the step of determining a degree of correlation comprises determining whether there is a match within a threshold range, and when there is a match, indicating that an alarming event has occurred.

In embodiments of the foregoing aspects of the invention, where the item of apparel is one of a plurality of items of apparel normally worn together as a set, for example a uniform, each item may further comprise means for registering each item as a member of the set, and means for detecting whether or not another item being worn at the same time is another member of the set and signalling if it is not.

A further object is to provide a method and system for detecting whether or not items of a uniform or other set of items of apparel normally worn together in fact are being worn together. Thus, according to a further aspect of the invention, there is provided a set of apparel comprising several items normally worn together, for example as a uniform, having means for registering each item as a member of the set, and means for detecting whether or not another item being worn at the same time is another member of the set and signalling if it is not.

The foregoing and other objects, features, aspects and advantages of the present invention will become more apparent from the following detailed description, taken in conjunction with the accompanying drawings, of preferred embodiments of the invention, which description is by way of example only.

### BRIEF DESCRIPTION OF DRAWINGS

In the drawings, identical or corresponding elements in the different figures have the same reference numeral.

FIG. 1 illustrates a first embodiment of the present invention in the form of items of apparel, specifically a uniform, having a biometric authentication/identification system;

FIG. 2 is a block diagram system overview of the apparel and sub-systems shown in FIG. 1;

FIG. 3a is a schematic representation of a pressure-sensitive insole having eight sensors for collecting biometric, specifically pedobarographic data;

FIG. 3b is a receive/transmit module of the system shown in FIG. 3a;

FIGS. 4a and 4b show sample plots of biometric data collected from the pressure sensitive insoles of FIG. 3a;

FIGS. 5a, 5b and 5c are high level schematic diagrams illustrating, respectively, Enrollment, Subsequent Acquisition and Authentication phases of the authentication system;

FIG. 6 is a generalized flowchart illustrating an enrollment phase according to one embodiment of the present invention, in which the system is initialized by acquiring and storing biometric data from a specified wearer under controlled conditions;

FIG. 7 is a generalized flowchart illustrating a subsequent data acquisition part of an authentication procedure according to one embodiment of the present invention;

FIG. 8 is a generalized flowchart illustrating an authentication part of the authentication procedure according to one embodiment of the present invention;

FIG. 9 illustrates a periodic nature of the signal from the sensor insole in one embodiment of the present invention;

FIG. 10 illustrates a generalized diagram of the threshold range according to one embodiment of the present invention, for comparison of acquired pedobarographic data against authenticated wearer profile(s); and

FIG. 11 is a graph of actual measured sensor data from two of the insole sensors in one embodiment of the present invention, taken from two people of near identical height and weight, both walking normally with sensor insoles in their shoes.

### DETAILED DESCRIPTION OF PREFERRED EMBODIMENT(S)

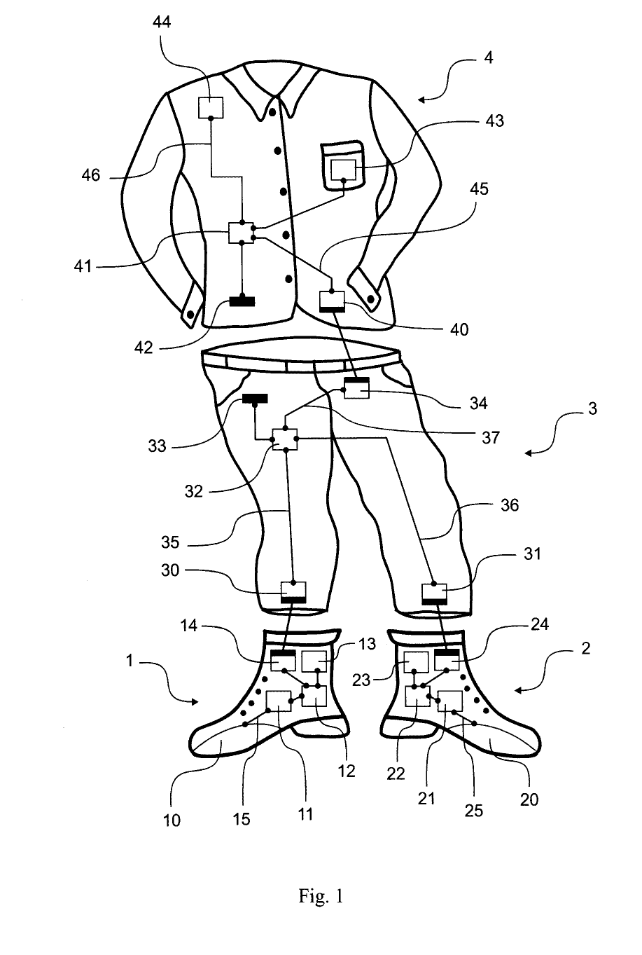

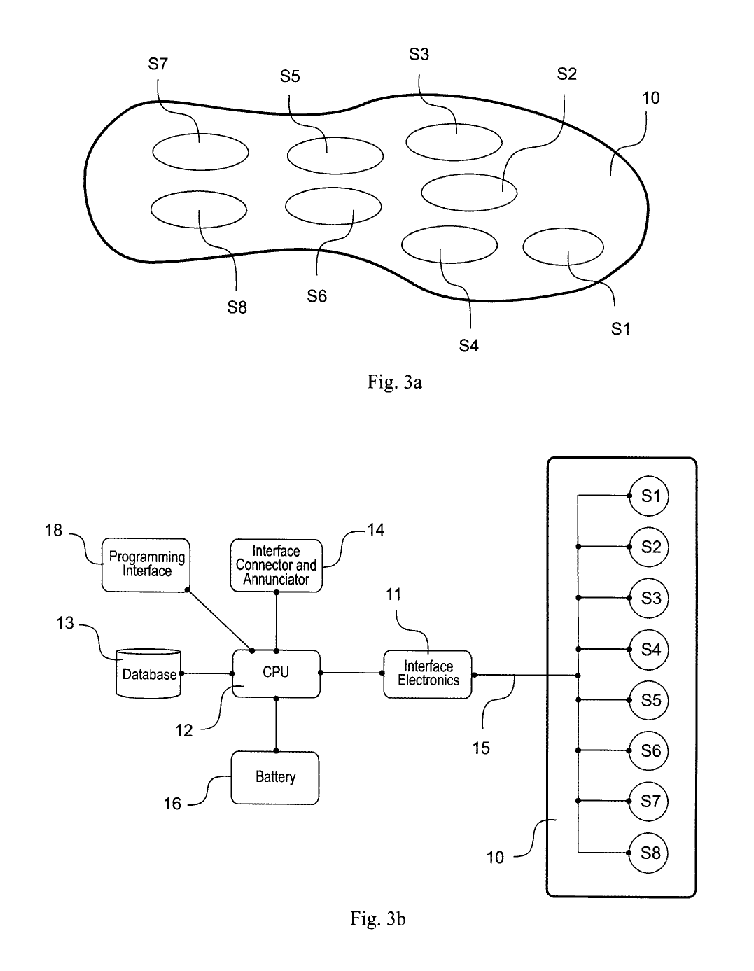

FIGS. 1, 2 and 3 illustrate an embodiment of the present invention, namely a uniform having a built-in system for characterizing a wearer, specifically for biometric authentication/identification purposes. The uniform comprises a pair of boots 1 and 2, trousers 3 and a jacket 4. The authentication/identification system comprises a pair of pedobarographic insoles 10 and 20 located appropriately inside the boots 1 and 2, respectively. The insoles are symmetrical (left and right foot) so only one is shown in more detail in FIG. 3a. This insole 10 has a set of sensors, for example S1-S8, distributed about its area and especially in the plantar regions. Each of the sensors S1-S8 can sense the pressure exerted by the part of the foot above the sensor. The sets of sensors are connected to respective interface electronics 11 and 21, also in the boots 1 and 2, respectively.

When the boots are being worn and the system is active, the insoles 10 and 20 send signals to the interface electronics 11 and 21 in boots 1 and 2, respectively, representing pressure values across the monitored surface areas beneath the wearer or user's foot, specifically the parts of the foot above the sensors S1-S8. Such pedobarographic insoles are known and available commercially for a variety of purposes, such as medical diagnosis and athlete training, so they need not be described in detail herein.

Although, for simplicity of the description, each of the insoles 10 and 20 comprises 8 sensors S1-S8, insoles with a much larger number of sensors are available and may be used if desired/required. Suitable insoles having 8 sensors presently are available from Zephyr Technology Ltd. of New Zealand under the trade/model name SHOE-POD™. Suitable insoles having 1024 sensors are available from Novel GmbH of Germany under trade/model name PEDAR™ and from Tekscan, Inc. of Boston in the United States under the name F-SCAN®. In practice, the number of sensors may be determined by the application. For example, while 24 sensors may provide sufficient accuracy for most authentication applications, more sensors may be required if identification is required and/or a large number of templates are to be compared.

The insoles 10 and 20 are connected by, for example, flexible printed circuit strips 15 and 25, to the interface electronics 11 and 21 which amplify and process low level signals from the sensors S1-S8 and supply them to microprocessors (CPUs) 12 and 22, respectively, which store data in respective storage units (databases) 13 and 23, respectively, as will be described in more detail hereinafter. Electronics interfaces 11 and 21 are specific to each insole type and are designed to translate the raw data from the sensors into a format that can be read and used by the CPUs 12 and 22. The CPU's 12 and 22 are connected to annunciator tag/connector interface units 14 and 24, respectively, which connect the CPUs 12 and 22 to corresponding connector interfaces 30 and 31 in the legs of the trouser 3 by way of connectors 50A and 51A at the tops of the boots 1 and 2 which connect to complementary connectors 50B and 51B at the adjacent ends of the trouser legs. The annunciator tags in the footwear may be conveniently integrated with the connector interfaces 14 and 24 as shown in the drawings or may optionally be separate units.

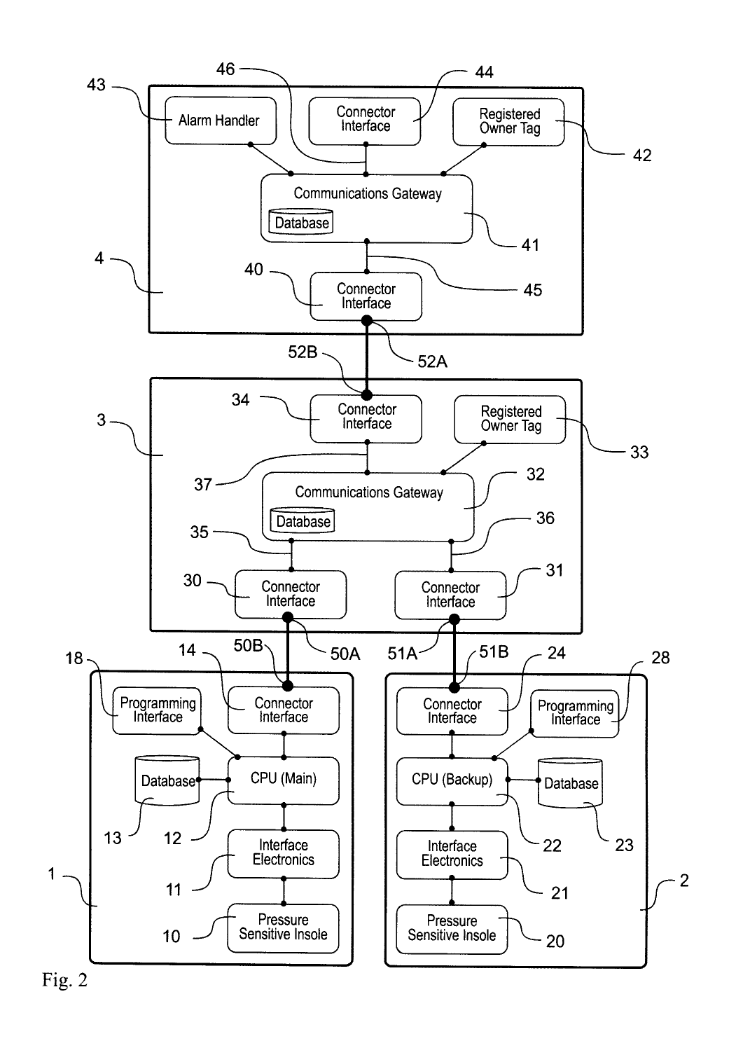

The CPUs 12 and 22 may be conveniently housed in the boots 1 and 2, respectively, for example, in the heels of the boots, but may also be housed proximal to the boot in an external location. Each of the CPUs controls the operation of the corresponding set of sensors S1-S8 and processes raw biometric data acquired from the sensors S1-S8. According to one embodiment, CPU 12 in left shoe 1 as shown in FIG. 3a is a “main” processor (master), whereas the CPU 22 in right shoe 2 is a “backup” processor (slave) which collects biometric data from the sensors in the right shoe but sends it to the main processor 12, via the communications pathways shown in FIG. 2 and to be described more fully later, for processing to generate a biometric signature for comparison with a previously-stored biometric signature to determine whether or not the wearer is authorized to wear the boots.

The processors, interface electronics, connector interface units and two sets of sensors are all supplied with electrical power by power supply units 16 (only one is shown in FIG. 3b) which may be battery-operated or include suitable known electrical power generating means, such as movement-based motion generators, and so on, known to those skilled in the art. The power supply units 16 may be conveniently located in the boots 1 and 2, respectively, such as in the heels, but may also be housed proximal to the boot in an external location. Other power sources, such as solar cells, might be used in addition to or instead of, perhaps integrated into the trousers or shirt.

As shown in FIG. 2, the lower connector interface units 30 and 31, respectively, of the trousers are connected via communications paths 35 and 36 to a communications gateway unit 32 which itself is connected to a registered owner/annunciator tag 33, and, via communications pathway 37, to an upper connector interface 34 at or about the trouser waistband which connects by way of a pair of connectors 52A and 52B to a complementary connector interface unit 40 of the shirt 4.

In this preferred embodiment, the connectors 50A-50B, 51A-51B and 52A-52B are wired connectors, specifically pairs of USB connectors, but optical fiber or wireless connections (R.F., IR, Bluetooth™, and so on) are also contemplated, with suitable adaptation of the connector interfaces; for example by incorporation of suitable optical or RF transceivers.

Connectors 50A-50B, 51A-51B and 52A-52B may be hidden so as to reduce the likelihood of an unauthorized wearer disabling the signal path. It is also contemplated that when the connectors 50A-50B, 51A-51B and 52A-52B are wireless, a relatively low strength signal is used between connectors to decrease power expenditure, and to decrease the area in which these wireless signals can be detected/intercepted.

The upper connector interface 34 of the trousers is connected via a lower connector interface unit 40 of the shirt 4 to a shirt communications gateway unit 41 via communications pathway 45. Shirt communications gateway unit 41 is coupled to a second registered owner/annunciator tag 42, an alarm handler unit 43 and, optionally, an upper connector interface unit 44 via communications pathway 46 for expansion purposes, for example, to connect to a helmet or any type of headwear. The registered owner/annunciator tags 33 and 42 may be unique to the authorized wearer and have a suitable unique identifier registered to the authorized wearer. The registered owner/annunciator tags 33 and 42 are conveniently depicted in the drawings as a single unit in each apparel item, but can also be implemented as two separate units in each apparel item, if desired.

These interface and communications components allow the main CPU 12 in shoe 1 to communicate signals to either or both of the annunciator tags 33 and 42 to signal whether or not the wearer is authorized to wear the boots. The boots 1 and 2 may also have “annunciator tags” for signalling in a like manner. The annunciator tags may be passive devices which communicate their authentication signals when interrogated by a complementary device. Suitable devices include wireless transponders, for example radio frequency transponders.

The “registered owner” tags are tags that are programmed at the time of assigning the apparel items to the specified individual whereas the annunciator tags are used for signaling to an outside person or system that the wearer is an unauthorized individual. Of course, both functions can be integrated into one tag. Signaling to an outside person or system that the wearer is an unauthorized individual by the annunciator tags can take many forms. For example, a visual alarm may be triggered, which flashes lights or a sign, or an audio alarm is triggered, each of which would quickly indicate to the public that the wearer is unauthorized. Alternatively, if it is desirable that the wearer is not aware that an alarm has been triggered, the system can incorporate a more subtle visual alarm, such as a change in the colouration of an item of apparel, perhaps limited to a specific area of the apparel. Furthermore, instead of or as well as the alarm manifesting on the wearer, the alarm signal may be relayed to a central monitoring system, which is used to remotely monitor security of an area.

In normal operation, the CPUs 12 and 22 collect incoming data from pressure sensitive insoles 10 and 20, pre-process the incoming data to validate the quality of the data, and then compute respective templates for subsequent comparison with the authorized wearer's biometric templates stored in the local databases 13 and 23. So long as the system, i.e., main processor 12, continues to detect an authorized person, it will continue to collect data. The comparison is made by the main processor 12 which, if it determines that an unauthorized person is wearing the boots, will notify the alarm handler 43 of this status, so, for example, a visual, audio or silent alarm, can be raised at the annunciator tags 14, 24, 33 and 42.

Simultaneously, the main processor 12 periodically will query the annunciator tags 33 and 42 in the trousers 3 and shirt 4 to confirm that “nothing has changed”, i.e., the “connection” between the items of apparel has been preserved. It is envisaged that a “keep alive” type of signaling will be used between the items of apparel to monitor their “connected” status. There are basically two main identity (ID) checks that are part of the start-up sequence when the person is dressing. The system may be designed to implement both checks when the person is dressing, however, it is possible that only one of the checks will be carried out. First, all items of apparel being worn and now connected to each other must be authorized to be worn together; this will come from the registered owner tags. Second, pedobarographic data from the normal movement of the person when compared to the stored reference data will confirm the identity/authenticity of the person. If the authorized person is wearing the right clothing, then the clothing system is GREEN and there is a high degree of confidence that “they are who they say they are”. Provided that the network of clothing elements has not been broken, that level of confidence is retained and only rechecked periodically. However, any time that network of clothing has been interrupted, for example when the wearer takes off his/her shirt, then the entire clothing network is re-validated and new pedobarographic data collected and re-authenticated.

If, independently of the biometric/pedobarographic data, the system detects that an unauthorized article of clothing has been added or replaced, it will notify the alarm handler 43 to provide the appropriate indication on the respective annunciator tags 14, 24, 33 and/or 42.

During normal operations, Main CPU 12 will receive data collected from the other insole, 20, sent from the Backup CPU 22, and apply algorithms on that data to provide a biometric signature. In programming mode, Main CPU 12 collects data from pressure sensitive insole 10 and stores it in the main database 13. It also then transfers that data, when possible, to Backup CPU 22, where it can be written to the Backup Database 23.

In normal operation, the Backup CPU 22 is regularly collecting incoming data from pressure sensitive insole 20, and sending the collected data to the Main CPU 12, for post processing. Periodically, Backup CPU 22 sends a “keep alive” signal to Main CPU 12 so the latter knows it can switch to the Backup CPU 22, if needed. In failure mode operation, the Backup CPU 22 may be required to take over from the Main CPU 12. This could either involve doing pedobarographic collection for one foot only, or operating at a reduced capacity for both feet, depending on the nature of the failure.

In normal operation, therefore, collected and processed biometric profile data is stored in the Main database 13 and a copy is stored in the Backup database 23. These databases contain all of the specified or authorized wearer biometric data used for authentication/identification. The Backup database 23 contains a copy of the specified or authorized wearer biometric data used for verification/identification tests. Under normal circumstances, this backup data is not used frequently, but may be required in the event that the Backup CPU 22 takes over active processing for the system.

According to another embodiment of the present invention, a simplified version of the system comprises only the footwear 1 and 2. In this embodiment, the aforementioned pieces of apparel, such as the shirt 4 and pants 3, are not included in the set, and therefore, the communications paths exemplified by connectors 50A-50B and 51A-51B are not required. Rather, the CPUs 12 and 22 in the footwear will communicate with each other through the annunciator tag/interface connectors 14 and 24.

In this embodiment, as with previous embodiments, at start up and periodically throughout use, the system may be programmed to check that all pieces of footwear are being worn and are connected to each other, through a “keep alive” type of signaling. The system may also be programmed to acquire pedobarographic data from the movement of the person, and compare this date to the stored reference data in the manner described above, which will confirm the identity/authenticity of the person.

Additional simplified systems are also contemplated, such as footwear with pants, footwear with shirt, footwear with hat, footwear with identification badge, or any combination thereof. In these systems, it is preferred that at least one article of apparel comprises an alarm handler to provide, for example, either a visual, audio or silent indication at the annunciator tag(s) of the user's identification/authentication status.

According to one embodiment, the Communications Gateway 32 in the trousers 3 handles a number of inter-garment communications functions, such as: communication from either CPU 12 or 22 (the latter in its backup mode) to the annunciator tag 33 on the trousers 3, communication from either CPU 12 or 22 to the interface connector unit 34 for communications with the shirt 4 and handles failure mode operations should there be a loss of communication with both CPUs 12 and 22 in the boots 1 and 2. It is envisaged that additional biometric data sensors is included in articles of clothing other than the boots, such as the shirt and/or trousers, in which case the Communications Gateway 32 would handle the collection of biometric data from these additional biometric sensors too.

The Communications Gateway 41 in the shirt 4 handles a number of inter-garment communications functions, such as: communication from either CPU 12 or 22 to the registered owner/annunciator tag 42 on this article of clothing, communication from either CPU 12 or 22 to the Interface Connector 44 on this article of clothing, communication from either CPU 12 or 22 with the Alarm Handler 43 and handles failure mode operations should there be a loss of communication with both CPUs and/or the Communications Gateway 32 in the trousers 3.

The Registered Owner Tags 33 and 42 each contain registered owner specific data related to their respective articles of clothing, trousers 3 or shirt 4. They may contain information identifying which other apparel items they may be worn in combination with. They may further contain biometric data associated with any additional biometric collection devices associated with their respective articles of clothing.

The Alarm Handler 43 is normally under the control of one of the CPUs 12 and 22, but possibly under the control of one of the Communications Gateways 32 or 41 under an error condition, to provide at least one of a visual, audio or silent indication of the user authentication status.

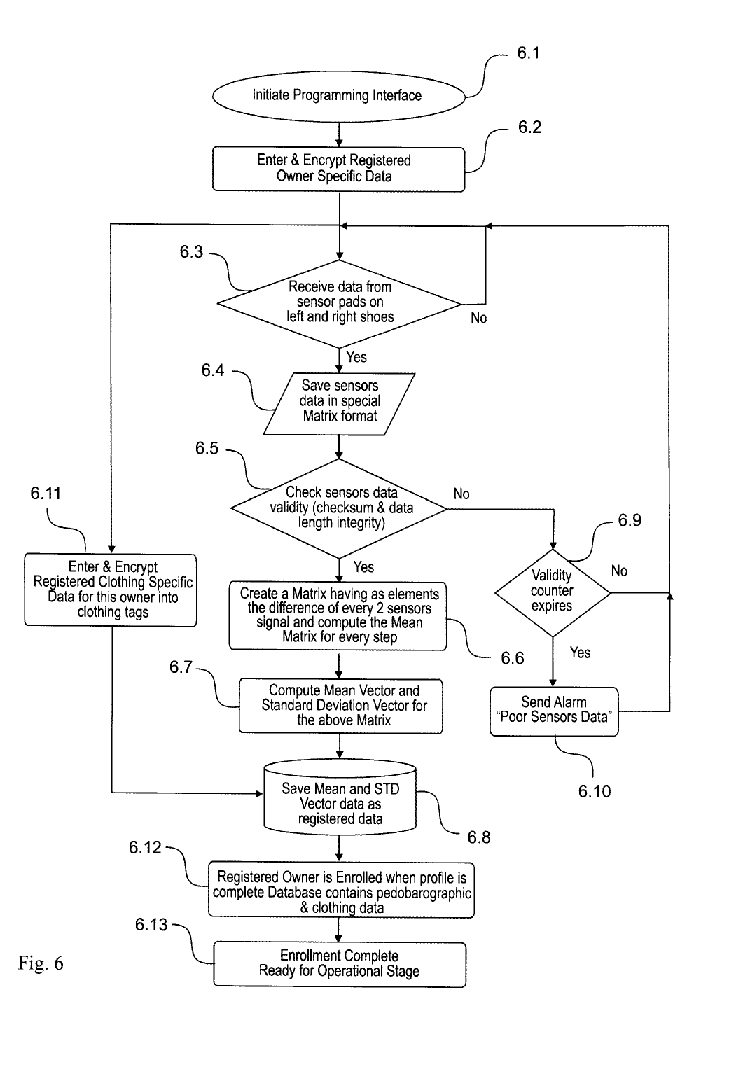

To initiate the programming as shown in step 6.1 of FIG. 6, each of the processors 12 and 22 must be told in a secure manner that a specified wearer template is to be created, so that it will be able to generate the pedobarographic template that will be stored in the respective one of Main and Backup databases 13 and 23 for that owner and be ready to store data related to the articles of clothing, 1, 2, 3 and 4.

When the uniform is issued to and donned by the authorized person, an initial “enrollment” procedure is carried out, under controlled conditions, to establish a biometric template or signature for that authorized person. An exemplary embodiment of the enrollment phase will be described hereinafter with reference to FIG. 6.

As illustrated in step 6.2 of FIG. 6, before collecting the pedobarographic data for a Registered Owner, the system must receive and store preferably in an encrypted manner, some specific information about the authorized wearer to be registered. This data may include, but is not limited to, owner name, date of template creation, owner/wearer security level, type of clothing, whether worn with other specific clothing, or tag identification number (Step 6.11). Biometric templates subsequently will be associated with this bibliographical information to create a profile for the authorized wearer. In the case of boots 1 and 2, this data may be input by a user via suitable programming interfaces 18 and 28 providing access to their microprocessors 12 and 22, respectively, and stored in the local Main and Backup databases 13 and 23 respectively shown in FIG. 2. If desired and appropriate, corresponding data is transferred to the annunciator tags 33 and 42 of the trousers 3 and shirt 4, respectively, via the Communications Gateways 32 and 41.

When the system is ready to begin accepting pedobarographic data for the purpose of adding one or more biometric templates to the profile for the Registered Owner/Wearer, the authorized person described above is asked to move about normally until told to stop. Data collection (step 6.3) will begin when movement starts and end when movement stops. As described above, both of the processors 12 and 22 will collect biometric data and preprocess it, but, in normal operation, only processor 12 will actually post-process it to generate an authorized wearer template.

After a predetermined number of steps by the wearer, or other measure of sufficient use, such as running, jogging, movement with varying weight loads etc., the main processor 12 will save the data from each of the two sets of sensors (right foot and left foot) in a prescribed matrix format (step 6.4), check its validity (step 6.5), then, in steps 6.6-6.12 attempt to post-process the data according to prescribed algorithms (an exemplary algorithm is described specifically later) and try to generate an owner profile. Thus, the processor 12 checks the usefulness of the data that has been collected for the purpose of generating an authorized wearer pedobarographic template. There needs to be sufficient valid data collected to allow a valid template to be created. If insufficient data has been collected at this stage, the integrity of the template will be compromised or it may not work at all to differentiate between wearers of the footwear. To prevent this from happening, if the main processor 12 decides there is insufficient data, it will return to Step 6.3 on FIG. 6 and continue reading pedobarographic data for more steps. If the processor 12 decides that enough data has been collected to create an acceptable template, it will write it to the database 13 as the authorized wearer profile. In normal operation, the backup processor 22 will have pre-processed the data from the right foot sensors, but will not have produced the matrix.

To complete the authorized wearer profile, after the basic authorized wearer data (name, etc.) for the system has been entered as above, and either before or after collecting the pedobarographic data for the authorized wearer reference template(s), the programming interface 18, 28 is used by the authorized user or a supervisor to input specific data relating to the articles of clothing which are to be worn with the registered footwear. It is envisaged that this will be done at the time of purchasing or when the authorized wearer is being assigned the footwear, typically depending upon whether the system is to be used in a civilian or military context.

When a pedobarographic profile has been created and wearer data and clothing data have been entered for the authorized wearer (Step 6.11), the profile is complete, the enrollment phase is complete and the programming interface can be disconnected (Step 6.13).

A wearer's authorized profile may, however, be updated or expanded upon at any time. The programming interface 18, 28 can be used to re-enter the enrollment phase and, for example, the wearer's pedobarographic profile can be expanded upon to include pedobarographic data indicative of various scenarios the wearer might encounter, such as an anticipated increase in weight load of the wearer, or an injury to the wearer that may cause an alteration in the wearer's gait and/or cadence, or any other likely scenario that the wearer is likely to encounter that may alter their pedobarographic profile.

According to a further embodiment of the present invention, once a wearer has been authenticated/identified as the correct wearer of the apparel, as long as a constant signal is generated that confirms that all of the items of apparel are still being worn by the correct wearer and are still connected to all apparel items in the set, any additional pedobarographic data generated during the day-to-day activities of the wearer can also be added to broaden the wearer's authenticated profile. This broadening of the wearer's profile may decrease the occurrence of false rejections.

According to one embodiment of the present invention, when the system is designed to perform self contained one versus many comparisons, such as to provide identification of a wearer, the CPU 12 and 22 is able to communicate with other CPUs from a predetermined group, or to a central monitoring CPU. This will allow the CPU 12 and 22 to update its database 13 and 23 with additional information, such as for example by adding new authenticated wearer profiles, updating pre-existing authenticated wearer profiles, or by adding information pertaining to which wearers have access to certain locations. It will also allow for an external system to limit access to facilities or equipment by querying the authentication status of the individual. If the external system receives a response indicating that the person has not been authenticated, it can take the same or similar actions as would be taken if an incorrect password or other ID failure occurred.

Subsequently, when the Registered Owner wears the uniform or clothing during normal day-to-day operations, equivalent new biometric data will be acquired and used to create new templates for comparison with the reference template(s).

Data acquisition to obtain a sensor data file, and data processing for the enrollment/registration phase, the authentication/verification phase and an identification phase are described in more detail in sections below entitled “A. Data Acquisition” and “B. Biometric Algorithm”.

To provide detection of persons misrepresenting themselves by wearing the apparel of another without requiring connection to external databases, preferred embodiments of the invention use a real-time matching process. There are no manual controls required to request an identity validation, and decisions are fully automatic. Once an owner has been successfully registered during the enrollment phase, the system remains in the authentication phase outlined below, which comprises acquisition and verification phases. The acquisition phase repeatedly acquires new biometric data from the sensors while, during the verification phase, the system checks the received data, and will quickly detect a fraudulent wearer of clothing registered to another. It may then generate an immediate response when an unauthorized wearer is detected.

According to one embodiment, when in operation, decisions made in the biometric identification phase are regulated by an error threshold range ‘T’, as shown in FIG. 10. There is a threshold for the left shoe 100 and the right shoe 102, where each threshold has an area of low correlation 104, 104′ and high correlation 106, 106′. Between the area of low correlation 104, 104′ and high correlation 106, 106′ is the threshold range T, defined by points of low threshold 108, mid threshold 110 and high threshold 112. The identification system has to account for two primary types of errors: (i) mistaking biometric measurements from two different individuals as being from the same person and (ii) mistaking biometric measurements from the same individual as being from different individuals. These two types of errors are denoted as false acceptance (FAE) and false rejection (FRE). The authentication phase is designed to eliminate these errors (see Note A in the Authentication Phase section). As will be described later, different specific thresholds may be involved according to the particular error determination required.

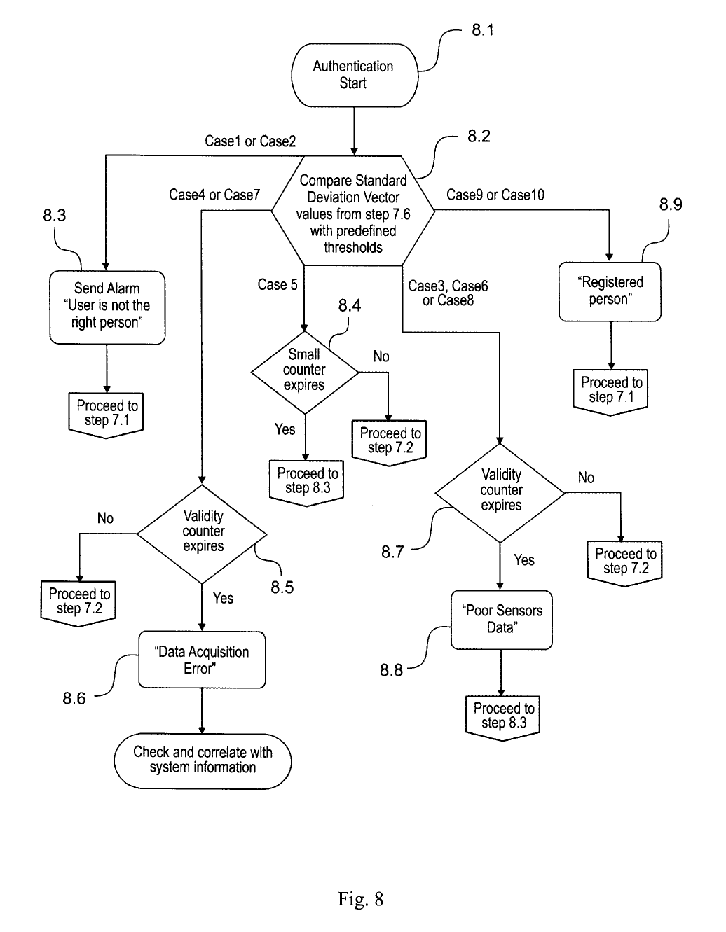

The verification phase according to one embodiment will be described in more detail later with reference to flowchart FIG. 8.

### A. Data Acquisition

This section describes generally data capture from each set of the foot sensors S1-S8. An exemplary method of data processing is also provided below. Alternative methods and software-based algorithms for processing the captured data and comparing with known data, typically in the form of a wearer profile, would be known to one of skill in the art when having regard to the present specification.

According to an embodiment of the present invention, during the Data Acquisition phase the 8× sensors pressure values are captured and saved in an original Matrix format for each foot: left and right. In this specific embodiment, using, for example, 8 sensors per foot, an NS×8 matrix is produced, NS being the total number of samples taken during the Data Acquisition phase.

Typically sensors have a 12 bit sensor pressure format, as illustrated in Table 1 below.

TABLE 1
12-bit Sensor Pressure format

| Byte | 0 | | 1 | | 2 | | 3 | | 4 | | 5 | |
|---|---|---|---|---|---|---|---|---|---|---|---|---|
| Nibble | 0 | 1 | 2 | 3 | 4 | 5 | 6 | 7 | 8 | 9 | 10 | 11 |
| Sensor | 3 | 3 | 5 | 3 | 5 | 5 | 4 | 4 | 2 | 4 | 2 | 2 |
| | 2 | 1 | 1 | 3 | 3 | 2 | 2 | 1 | 1 | 3 | 3 | 2 |
| Byte | 6 | | 7 | | 8 | | 9 | | 10 | | 11 | |
| Nibble | 12 | 13 | 14 | 15 | 16 | 17 | 18 | 19 | 20 | 21 | 22 | 23 |
| Sensor | 6 | 6 | 1 | 6 | 1 | 1 | 7 | 7 | 8 | 7 | 8 | 8 |
| | 2 | 1 | 1 | 3 | 3 | 2 | 2 | 1 | 1 | 3 | 3 | 2 |

Data is captured to provide an 8× Sensor Data File see Table 2 below, i.e. a readable file to be used as input for further processing.

TABLE 2
8× Sensor Data File example

| Sensor | Sensor | Sensor | Sensor | Sensor | Sensor | Sensor | Sensor |
|---|---|---|---|---|---|---|---|
| 3 | 5 | 4 | 2 | 6 | 1 | 7 | 8 |
| 3011 | 3344 | 3388 | 3417 | 3259 | 3305 | 3453 | 3549 |
| 3016 | 3344 | 3390 | 3419 | 3264 | 3303 | 3448 | 3548 |
| 3017 | 3347 | 3390 | 3419 | 3267 | 3305 | 3450 | 3544 |
| 3019 | 3350 | 3389 | 3422 | 3265 | 3303 | 3456 | 3547 |
| 3018 | 3356 | 3385 | 3418 | 3263 | 3307 | 3451 | 3550 |
| 3017 | 3359 | 3390 | 3419 | 3265 | 3304 | 3457 | 3548 |
| 3020 | 3357 | 3394 | 3418 | 3264 | 3303 | 3451 | 3552 |
| 3023 | 3354 | 3394 | 3419 | 3265 | 3305 | 3453 | 3549 |
| 3021 | 3356 | 3393 | 3417 | 3263 | 3306 | 3451 | 3548 |
| 3023 | 3357 | 3395 | 3417 | 3263 | 3304 | 3456 | 3548 |
| 3023 | 3359 | 3393 | 3421 | 3266 | 3304 | 3450 | 3547 |
| 3021 | 3359 | 3393 | 3421 | 3266 | 3304 | 3454 | 3551 |
| 3022 | 3358 | 3392 | 3420 | 3266 | 3308 | 3453 | 3546 |
| 3022 | 3363 | 3392 | 3421 | 3264 | 3306 | 3452 | 3549 |
| 3025 | 3359 | 3395 | 3419 | 3263 | 3305 | 3454 | 3550 |
| 3019 | 3361 | 3399 | 3419 | 3264 | 3304 | 3454 | 3548 |

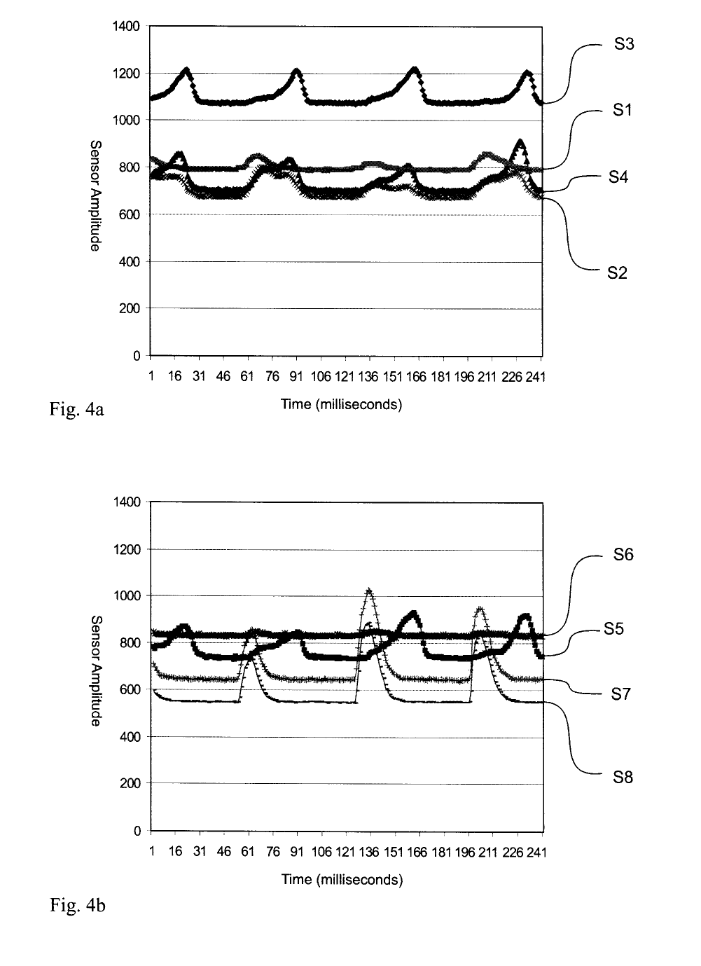

As an example, FIGS. 4a and 4b shows a plot of 8× Sensor data values gathered from a walking subject. In the plot, periodic (sinusoidal-like) type pattern for each sensor become apparent. In this example, about 250 data points represent several footsteps, and were collected over a time period of 7 seconds.

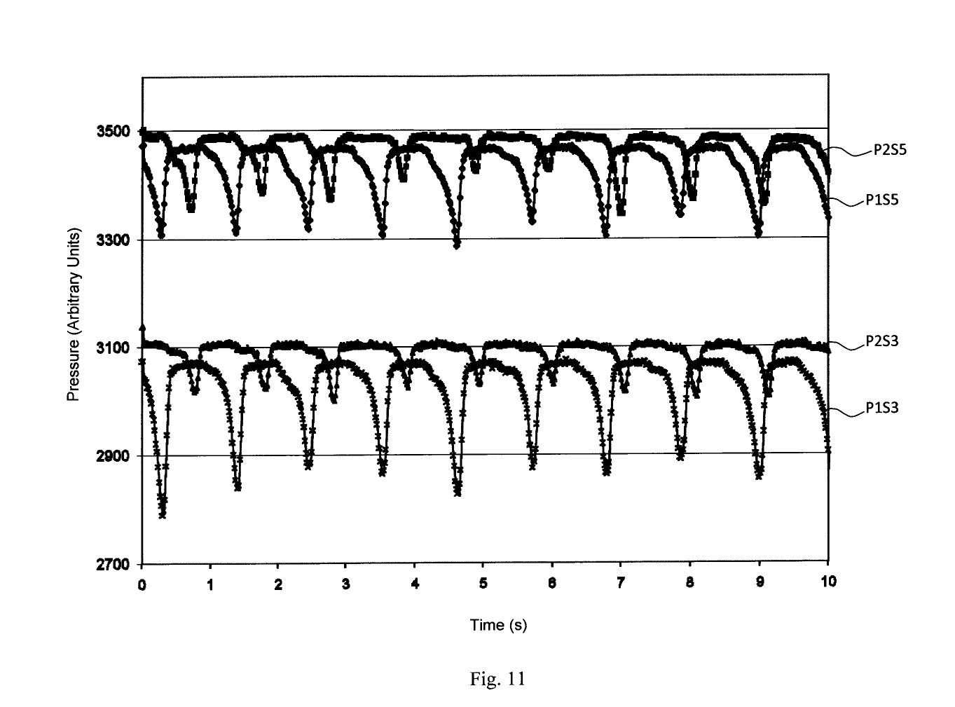

A further example is illustrated in FIG. 11, where there is shown a graph of actual measured sensor data from two subjects P1, P2. Both subjects P1, P2 had a height of about 67 inches and a weight of about 162 pounds. Both subjects walked normally with their typical gait and cadence, followed the same walking route on the same hard surface, and used the same shoes with the same insoles of the present invention. Pressure data for both subjects from eight sensors was measured during a forty second time period. The pressure data generated from sensor three S3 and sensor five S5 over a span of ten seconds from the middle of this time period, is shown in this figure. In this embodiment, the pressure data is captured as an analog signal from the insole sensors, which was then converted to a digital signal using an analog-to-digital converter. The digital signal generated from each insole sensor is proportional to the amount of pressure placed on each insole sensor, and is displayed in FIG. 11 in arbitrary pressure units. The measured data shown in FIG. 11 illustrates the profiles that are generated for a wearer, and specifically shows the differences in data profiles that are generated from two subjects having near identical weight and height using pedobarographic data. Comparisons of pedobarographic data against profiles generated in this manner can be used to authenticate/identify a wearer.

### B. Main Application

The main application software is responsible for handling the biometric data collection and analysis in three phases: enrollment, subsequent acquisition and authentication.

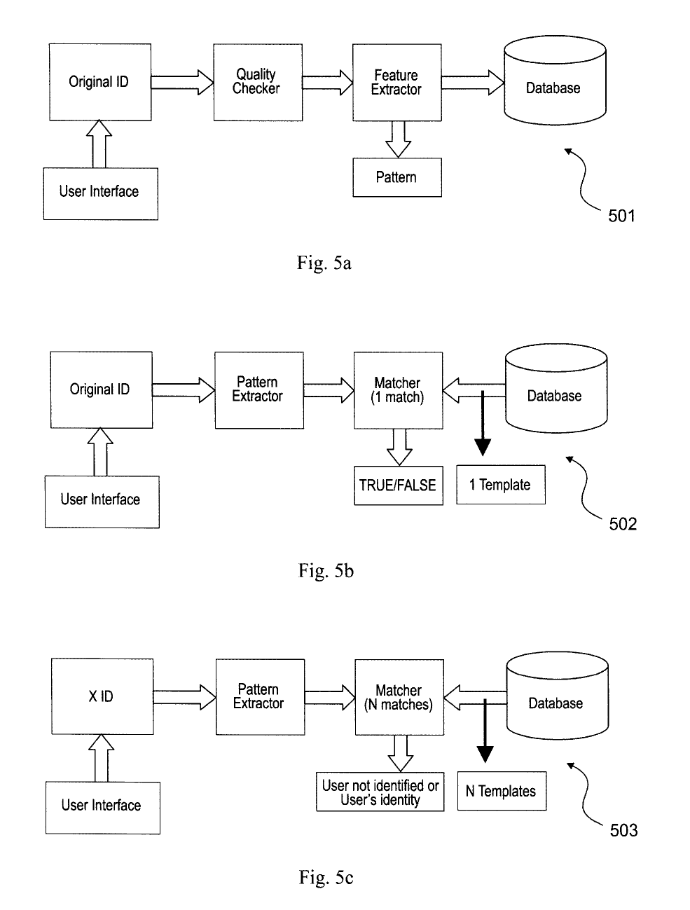

According to one embodiment, as illustrated in FIGS. 5a, 5b and 5c, the authentication/identification system has an initial so-called enrollment phase (FIG. 5a) and a later authentication phase (FIG. 5b). Additionally or alternatively, the system may have an identification phase (FIG. 5c). During the enrollment phase, individuals are enrolled in the system by capturing at least one biometric characteristic of each individual, using a biometric sensor, while the individual is wearing the item of apparel under controlled conditions, to produce reference biometric data which is processed (quality checking, feature extraction) to generate a reference template which is stored in the central database of the biometric system and/or recorded on a magnetic card, smartcard or read-only memory device (ROM). Subsequently, during the authentication/identification phases, the system captures, conveniently in a similar manner, “current” biometric data of a wearer claiming to be a specified enrolled individual and compares the data with the previously-stored data (template) in the database.”

### Enrollment Phase

The Enrollment phase involves real-time data acquisition of the targeted enrolled person while wearing the apparel. The exemplary algorithm as detailed herein computes a Mean Vector and a Standard Deviation Vector for each foot under test, the collected data being saved locally for further analysis and test. This becomes the reference biometric data, providing a reference template to be used later, during the authentication phase, to evaluate newly-acquired biometric data and corresponding templates.

### Algorithm:

### Step 1:

Data for both feet: left and right, are acquired (step 6.3 of FIG. 6) from the sensors as foot pressure values, processed and saved as an L×N Matrix (step 6.4), where:

L=number of iterations captured from the sensors for each foot.

N=number of sensors per foot (8 in this specific embodiment)

The acquired sensors data integrity has to be checked (step 6.5) using a checksum validation formula or/and data length validation, refer to step 6.9 and 6.10.

### Step 2:

In step 6.6, a basic Differential Matrix is computed using simple factorial combinatorics, where every element k is a result of the next formula:

For every sensor data sample:

A(k)=S(i)−S(j), (1)

where k=0 to K, see explanation below

K=N!/(2!(N−2)!), (2)

i=1 to N, max number of sensors

j=2 to N, max number of sensors

N=the number of sensors (8 in this embodiment).

K is the maximum possible number for combination of N taken as 2, where N is the maximum number of sensors. Differential Matrix size is L×K.

### For N=8→K=28

Rationale: The difference value between data from 2 individual sensors, S(i)-S(j), is used in order to normalize the data and eliminate the specific body pressure from weight alone.

### Step 3:

Based on this Differential Matrix, a second Matrix containing the Mean of the differential values for every step is computed (6.6). The resulted N×K Mean Matrix has K columns and S rows, where S is equal to the number of steps taken by the individual under test.

K=28, N=8 in this specific embodiment.

### Step 4:

Determination of steps taken by the wearer: Since the gait of an individual walking is approximately a periodic function of alternating left and right steps, every step has to be sized and a corresponding Mean value computed. As the cadence and step size varies, even for a given individual walking normally, the gait or periodicity of walking is determined by an algorithm capable of computing an elastic window size for every step, during the walking of the enrolled/verified person.

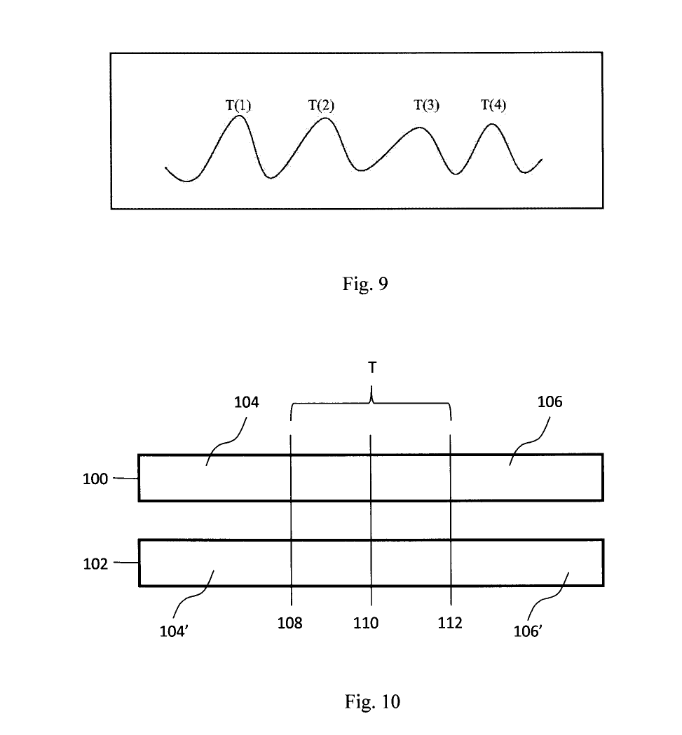

To determine the gait for an individual, the size of the elastic window is marked by two consecutive maximum sensor's values, as seen in FIG. 9. The length of the windows is equal to the number of iterations between 2 consecutive peaks:

W(i)=T(i+1)−T(i); where: i=1 to L (number of iterations captured from the sensors)

### Step 5:

Finally the algorithm computes (step 6.7) the Standard Deviation vector, STD( ) based upon the value of every Matrix element in the Mean Matrix, (see equation 4) and the Mean vector (see equation 5), and stores (Step 6.8) the result in a Deviation Vector [1,K] and Mean vector [1,K]. In this specific embodiment, K=28.

STD(A)=SQRT(Σ(A−Ā)*(A−Ā)/S) (4)

where:

Ā=Mean(A)=1/S*Σ(A) (5)

A is the Mean Matrix of the Differential Matrix computed per step;

S is the number of steps;

SQRT( ) is the square root function of the content between brackets; and

Ā or Mean (A) is a 1×K Mean Vector.

Under normal circumstances, both left and right foot information and data are used in the algorithm and hence 2× Standard Deviation Vectors and 2× Mean Vectors are stored: this results in a value of 2×K (specifically 2×28=56) numbers to be used in the correlation, each time an acquisition and authentication are performed.

The Standard Correlation Vector, Mean Vector and Threshold Data may be encrypted when stored and measures taken so as to protect from unauthorized access.

### Subsequent Acquisition Phase

The Subsequent Acquisition Phase is initiated periodically under routine conditions and in specific circumstances when necessary to determine whether or not the individual wearing the apparel is the authorized (enrolled) person. This may occur at regular timed intervals, or may be initiated, for example, at specific locations, such as if the wearer attempts to gain access to a location.

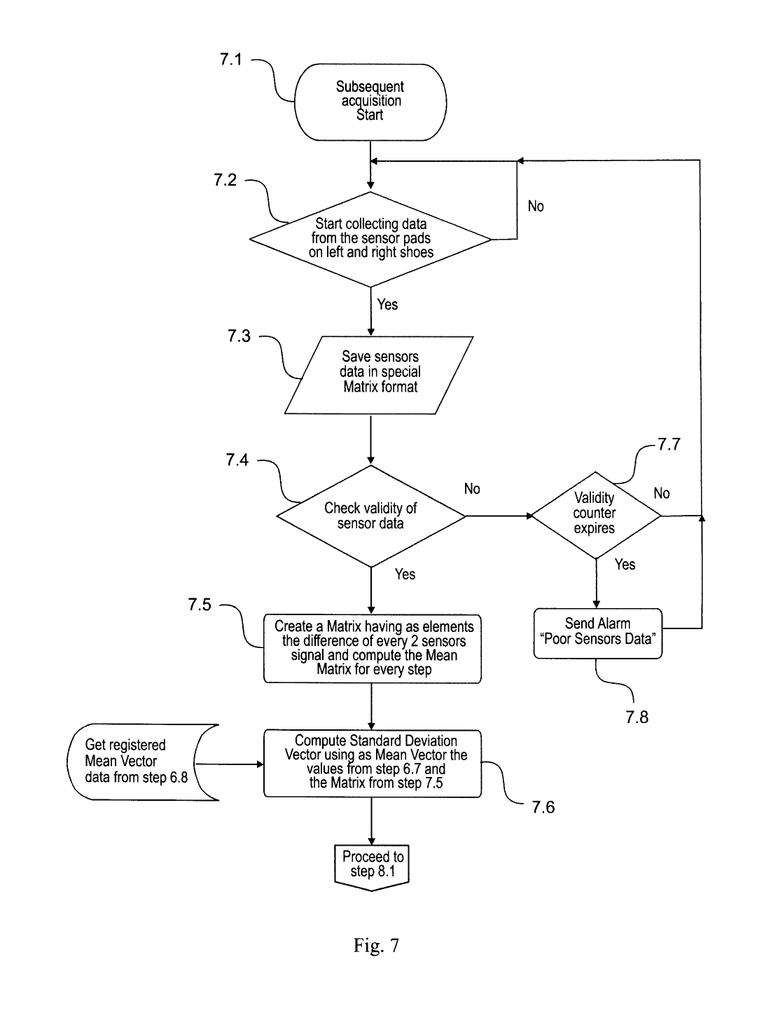

An exemplary embodiment of the Subsequent Acquisition Phase will now be described more specifically with reference to the flowchart in FIG. 7.

Following initiation in Step 7.1, the processor 12 starts running (for each foot) a new Data Acquisition phase, collecting data from Sensors S1-S8 in Step 7.2 and then, in Steps 7.2-7.6 applying algorithms and functions, for example, similar to those as described above with reference to FIG. 6, in order to compute a new Deviation Vector. Therefore the Subsequent Acquisition Phase Algorithm has to repeat and re-compute the values obtained earlier in Step 1 to Step 5 of the Enrollment Phase, but having the new sensors data as input data, and compare the Mean Matrix (A) with the previous one, computed based on the authorized wearer's biometric data and the stored values (step 6.8). Under normal circumstances, the new Standard Deviation Vector for both feet will be used as Input for the Verification phase.

### Authentication Phase

An exemplary embodiment of the authentication phase is illustrated in FIG. 8. The authentication phase follows the Subsequent Acquisition phase, and correlates the Deviation Vector values from the Subsequent Acquisition Phase with the reference template values previously saved during the Enrollment Phase. The correlated values are compared with pre-determined threshold values, (step 8.2). Threshold values are described below in NOTE A; however, the values are subject to change during the testing, in order to improve FRE and FAE.

There are two types of thresholds: namely a level or a ratio (or percentage). One “level” threshold (of 10) is defined for the Standard Deviation Value and three “ratio” threshold values are defined as Low, Middle and High Thresholds, as illustrated in FIG. 10.

These last threshold values may be defined as ratios or percentages and there are more cases to be considered and analyzed, as shown in FIG. 8 where: Step 8.3 defines Case 1 and Case 2 conditions when the data acquired and computed during the most-recent Subsequent Acquisition Phase do not correlate with the data saved at the Step 6.8 during the Enrollment phase.

Step 8.4: Case 5, covers the situation where the acquisition phase has to be repeated once to clear an ambiguous situation.

Step 8.5 and 8.6 depict a data acquisition error case, see Case 4 and Case 7 conditions.

Step 8.7 defines Cases 3, 6 and 8 when data are not accurate enough to come to a conclusion and, if persistent, one or more other identification/authentication criteria have to be used, (see Step 8.8).

Step 8.9 defines Case 9 and 10 conditions when the computed values from Step 7.6, FIG. 7, correlate with the values saved as indicated by Step 6.8, FIG. 6 and yet the “Registered person” was validated during the last Subsequent Acquisition Phase.

Each particular case will now be described more specifically. Refer to FIG. 10 for a depiction of left 100 and right 102 feet showing the threshold range T, including High 112, Low 108 and Middle 110 Threshold structure.

Case 1: Ratio of the values inside the Deviation Vector smaller than the Level Threshold value is less than Low Threshold value 104, 104′ for both feet (left 100 and right 102).

Case 2: a Ratio of the values inside the Deviation Vector smaller then the Level Threshold value is less than Low Threshold value for one foot and is between Low and Middle Threshold values for the other foot.

Case 3: a Ratio of the values inside the Deviation Vector smaller then the Level Threshold value is less than Low Threshold value for one foot and is between Middle and High Threshold values for the other foot.

Case 4: a Ratio of the values inside the Deviation Vector smaller then the Level Threshold value is less than Low Threshold value for one foot and is bigger than High Threshold value for the other foot.

Case 5: Ratio of the values inside the Deviation Vector smaller then the Level Threshold value is between Low and Middle Threshold values for both feet Vectors (left and right).

Case 6: a Ratio of the values inside the Deviation Vector smaller then the Level Threshold value is between Low and Middle Threshold values for one foot and is between Middle and High Threshold values for the other foot.

Case 7: a Ratio of the values inside the Deviation Vector smaller then the Level Threshold value is between Low and Middle Threshold values for one foot and is bigger then High Threshold value for the other foot.

Case 8: Ratio of the values inside the Deviation Vector smaller then the Level Threshold value is between Middle and High Threshold values for both feet Vectors (left and right).

Case 9: a Ratio of the values inside the Deviation Vector smaller then the Level Threshold value is between Middle and High Threshold values for one foot and is bigger then High Threshold value for the other foot.

Case 10: Ratio of the values inside the Deviation Vector smaller then the Level Threshold value is bigger than High Threshold value for both feet (left or right).

These cases results in 5 different approaches and 4 decisions:
1> Cases 1 and 2: The result is clearly negative, the wearer of the footwear is not the authorized wearer (eg: an intruder) and an Alarm has to be issued. (Step 8.3)
2> Cases 3, 6 and 8: The result is ambiguous, more data acquisition from the Sensor Pad has to be initiated and the Identification Phase resumed. (Steps 8.7 and 8.8).
3> Cases 4 and 7: The results for both feet are very different so these are Data Error cases, more data acquisition from the Sensor Pad has to be initiated and the Identification Phase resumed. (Steps 8.5 and 8.6).
4> Case 5 is a case of limited ambiguity: Ratio of the values inside the Deviation

Vector are smaller than the Level Threshold or value is between Low and Middle Threshold values for both feet Vectors (left and right). The small counter is incremented by one. The result is ambiguous but tending towards a negative conclusion so another data acquisition from the Sensor Pad is initiated and the Identification Phase resumed. (Step 8.4)
5> Cases 9 and 10: The result is clearly positive; the wearer of the footwear is the authorized wearer (eg: registered owner) of the footwear. (Step 8.9)

For Cases 3, 4, 6, 7 and 8, a Validity Counter is used in order to limit the Data Acquisition Phase. The validity counter is incremented by one each time data is collected and deemed invalid or ambiguous, in order to limit the number of attempts to collect data before declaring that data being collected is not usable. When the validity counter has expired, a Poor Sensor Data condition is generated and the individual cannot be authenticated and an alarm is raised.

For Case 5, the Acquisition Phase has to be repeated once more before a conclusion is reached, (especially if negative).

If, in cases 3, 6 and 8, the ambiguity is persistent and the Validity Counter expires, different criteria (such as: body weight, gait, cadence or Center of Pressure) may be used to help in reaching a conclusion.

In the case of Data Acquisition Error, which may arise for many reasons, including hardware issues, sensor pad issue, environment conditions, etc., after the expiration of the Validity Counter a checking and correlating with other system information will/may be performed (for example: pants Id versus shirt Id).

NOTE A: Level Threshold has a value set at 10

Low Threshold has a value set at 10

Middle Threshold has a value set at 17

High Threshold has a value set at 20.

Validity Counter has a value set at 4.

Small Counter value is set at 2

Thus, once the enrollment procedure shown in FIG. 6 has been completed, the template stored in the local system Main and Backup databases 13 and 23, respectively, for the authorized wearer of the clothing, boots 1 and 2, pants 3 and shirt 4, meets the following important criteria needed for the biometric system to function:

Universality: any person wearing that clothing will normally also generate the biometrics that have been collected.

Distinctiveness: the combination of the biometrics being collected varies sufficiently between individuals to serve as a valid differentiator.

Quantitative: the biometrics being collected are quantitative in nature and can be measured and compared as quantitative data sets.

Permanence: the biometrics being collected are sufficiently invariant over a period of time with respect to the matching criteria used by the system to serve as valid inputs.

Performance: the resource requirements for real time data analysis and identification recognition accuracy of the biometric data collected is sufficiently low that it is feasible to construct a very small and highly portable microprocessor based system embedded in apparel protected by biometric authentication system.

The result could be a positive one indicating the person is the authorized wearer, or a negative one: someone other than the authorized wearer, such as an intruder, is wearing the apparel. In this case the system outputs an Alarm indication of some kind, which may be visual, audible, electronic (wireless or infrared) or a combination of the above.

The correlation value between the newly measured data and the previously stored owner data is checked against a threshold, as is typically seen in a biometric system description.

A biometric system embodying the present invention could operate either as an on-line system (i.e., real time) or an off-line (i.e., not real time) system. An on-line system requires the recognition to be performed quickly and an immediate response made. On-line systems may be fully automatic and require the biometric characteristic to be captured, the enrollment process to be unattended (no manual control) and the matching and the decision to be fully automatic. Off-line systems, however, typically may be semi-automatic; the biometric acquisition could be off-line, the enrollment may be supervised, a manual quality check may be performed to ensure good quality acquisition, and the matcher may return a list of candidates which are then manually examined to arrive at a final decision.

This data is collected and used in real time, if desired together with data from a network of other sensors in the clothing of the wearer, to maintain a user profile that identifies the wearer without having to use external database systems for validation. All of the data necessary to detect an unauthorized person preferably is stored locally, within the system, i.e., in, on or in association with the item of apparel itself.

It is envisaged that, when the wearer first dons the apparel, a full authentication will be performed following which, if the wearer is authenticated, the system will enter a “GREEN” or “confident” state. If the integrity of the system is undisturbed and the person sits down, there is no need to continue checking, i.e., repeating the authentication process. Any data from the footwear collected while the person is seated (or standing still for that matter) would be of little or no use in terms of being able to ascertain or confirm the identity.

The pressure-sensitive pads may be insoles in the person's footwear. For the initial registration/enrollment phase, the pressure-sensitive pads may be separate mats upon which the person walks, typically without footwear.

It is envisaged that the signal paths might be embedded into the fabric of the respective items of apparel, for example optical fiber woven into the fabric, or might be wireless signal paths. In either case, the signal path preferably is not readily visible or detectable so as to reduce the risk of tampering.

The annunciator tags 14, 24, 33 and 42 may be incorporated into the corresponding item of apparel and emit, e.g. display, the unauthorized wearer alarm signal in such a way that it is not apparent to the unauthorized person. The tags could be a badge or other emblem or a pattern of fibers or other display elements woven into the fabric of the apparel to create a display panel for displaying the alarm signal.

The various components of the system might be located in different parts of the apparel (clothing/footwear/headwear etc.) as compared with the above-described embodiment. In one embodiment, the pressure sensitive pad is integral to the footwear, i.e., built into it during manufacture. Moreover, the microprocessor and the database in the shoe. Also, although trousers have been described, if desired, they can be replaced by a skirt or other garment.

Although the above-described embodiments of the invention comprises a system and method of authenticating/identifying authorized individuals, it is envisaged that embodiments of the present invention are used to monitor individuals, such as the elderly or infirm, in case they need medical or other assistance, or be used to track the location of individuals as they move about a facility.

Although, in the above-described embodiment, the previously-collected biometric data is stored locally and compared with the current biometric data locally, it is also envisaged that the previously-stored data is stored at a remote location, and the device which interrogates the annunciator tag forwards the newly-acquired biometric data, or at least the template, to the remote location for such comparison, the remote location returning the result of the comparison to the interrogation device.

It should be appreciated that the present invention is not limited to denying unauthorized access to buildings or compounds, but also embraces systems and methods for restricting access to or control of equipment, whether military or civil. For example, the system might be used to prevent a person starting or driving a vehicle, or gaining access to a computer, if the system had determined they were unauthorized.

Although embodiments of the invention permit local, self-contained authentication/identification, it is envisaged that they can also communicate, for example wirelessly, with a central monitoring or command station, perhaps for surveillance or tracking reasons. They may also be used for Identification-Friend-or-Foe (IFF), perhaps integrated with existing IFF systems to provide additional verification/confirmation of identity of individuals.

According to one embodiment of the invention, the present system and method is used to detect unusual situations, such as alarming events, evidenced by the same or similar action manifested by one or more individuals. For example, if the system receives pedobarographic data consistent with an individual or a group of individuals from the same location that are, e.g. inexplicably running, this could be indicative of some form of emergency situation, such as a fire or an altercation.

In such a situation, an alarm status or an indication of an alarming event can be raised by the system, perhaps dependent upon whether a degree of correlation between the current status template (i.e. the most recently generated template) and an alarm template (i.e. a template that correlates to running, jogging, lying down or another uncharacteristic action of the wearer), for one or a plurality of individuals, is within a threshold range, as opposed to if the current template correlates with a normal template (i.e. a template that correlates to walking, or an event common to the wearer's day-to-day activity).

According to a further embodiment of the present invention, when a wearer approaches or enters into a restricted area, an identification and/or authentication step is performed by the wearer's system. This step may be triggered by communication with an external device situated at or near the restricted area, or may be triggered remotely whenever a wearer approaches this area. If the wearer is authenticated and/or identified as someone with access for this restricted area, no alarm is triggered. However, if the wearer is not authenticated and/or identified as someone without access for this restricted area, then an alarm is triggered. The alarm may be a silent alarm, such that the trespasser will be oblivious to the alarm.

Embodiments of the invention may also be used to restrict egress from a location, such as a penitentiary. For example, according to one embodiment, if a wearer outfitted with the footwear of the present invention attempts to gain access to a passageway that is obstructed by, for example, a door, gate, turnstile, fence, or the like, a CPU would detect the wearer approaching and initiate a method of the present invention in order to authenticate and/or identify the wearer based upon pedobarographic data. In one embodiment, the local CPU is coupled to and controls the door, gate, turnstile, fence or the like, and if the wearer is authenticated, or is identified as a person with proper clearance, access to the passageway is granted, i.e. the door, gate, turnstile, fence, or the like opens. If the person is not authenticated, or is not identified as a person with proper clearance, access to the passageway is denied, i.e. the door, gate, turnstile, fence, or the like does not open. Optionally, if a wearer without proper clearance attempts to gain access to passageway that exits or enters place, an alarm is sounded either locally or remotely to alert the proper authorities.

Generally, for military or other high security applications, such as law enforcement, penitentiaries, and, possibly, hospitals or other medical environments, wired connections between the apparel items might be preferred because they are less susceptible to interference, and would be more difficult to detect with RF detectors, or otherwise intercept, and so on. Wireless connections, in which the interfaces of the respective apparel parts communicate via suitable radio or optical transceivers, may be preferred in these or other environments if interference and security are less important.

It is envisaged that, although the above-described embodiment uses removable pedobarographic insoles, the invention embraces embodiments in which the sensors are embedded directly into the inner sole of the footwear.

Although the above-described preferred embodiment has only eight sensors for acquiring biometric data, it will be appreciated that the number of sensors may vary according to the particular application, perhaps taking into account a trade-off between accuracy and operational speed as the number of sensors increases.

Although the above-described embodiment uses the same item of apparel to collect the initial biometric data from the specified wearer under the controlled conditions, it is envisaged that an initial biometric data set is obtained from the specified user by means of a similar item of apparel or other means and downloaded into the storage device of the item of apparel issued to the specified wearer.

It is envisaged that the interconnection of a set of items of apparel having means for registering the items as a set to be worn together, and detecting if and when at least one item is missing, is not limited to the above-described biometric sensing embodiment but may also be used where none of the items of the set have biometric sensing means. Such a system can be used in detecting when at least part of a set of apparel, for example a uniform, has been stolen.

Biometric authentication/identification/characterization systems embodying the present invention serve to prevent impersonation of uniformed staff in a civilian or military context and may provide a high degree of confidence that anyone wearing apparel protected by the system is authorized to be wearing that apparel. When the system detects that an unauthorized person is wearing apparel registered to another person, it can provide a visual indication or a silent security alert allowing others to take appropriate action, or can be configured to trigger external alarms or prevent access to restricted areas. Embodiments of the invention may accomplish this without reliance on external database systems. Embodiments having means for linking items of a set of apparel and indicating when one or more items of the set is missing advantageously may be used to indicate that the apparel, for example a uniform, has been stolen.

Although various embodiments of the invention have been described and illustrated in detail, it is to be clearly understood that the same is by way of illustration and example only and not to be taken by way of limitation, the scope of the present invention being limited only by the appended claims.

1-71. (canceled)

72. A method of characterizing a wearer of at least one item of apparel having sensor means for sensing biometric data about the wearer, comprising the steps of:
while the wearer is wearing the item of apparel, acquiring from said sensor means biometric data that is characteristic of the wearer;
comparing the biometric data with reference biometric data including corresponding biometric data previously obtained under controlled conditions while the same or a similar item of apparel was being worn by a specified person; and
in dependence upon the result of the comparison, providing an output signal indicating whether or not the wearer is the specified person.

73. A method according to claim 72, wherein the item of apparel comprises footwear, the sensor means comprises pressure-sensitive sensor means of said footwear and the biometric data comprises pedobarographic data, preferably kinetic pedobarographic data, obtained from said pressure-sensitive sensor means.

74. A method according to claim 72, wherein the step of acquiring biometric data from the sensor means is repeated at predetermined intervals while the item of apparel is being worn, said comparison step correlates newly-acquired biometric data with said corresponding biometric data, if the correlation is less than a predetermined degree, determines that the wearer is not the specified person and provides said output signal to that effect, and, optionally, if the correlation is at least equal to the predetermined degree, uses the newly-acquired biometric data to update the reference biometric data, subsequent comparisons then comparing subsequently-acquired biometric data with the updated reference biometric data.

75. A method according to claim 72, wherein the corresponding biometric data is stored locally in or in association with or proximal to the item of apparel.

76. A method according to claim 72, further comprising the step of detecting activation of the sensor means following a period of deactivation and performing at least a first step of acquiring biometric data from the wearer.

77. A method according to claim 72, wherein the comparison step determines the identity of the wearer.

78. A method according to claim 72, further comprising the step of registering a unique identifier to the specific person and storing said corresponding biometric data in association with said unique identifier.

79. A method according to claim 72, wherein the step of acquiring biometric data from the wearer comprises the steps of:
monitoring the sensor means to obtain pedobarographic biometric data of the wearer at predetermined intervals;
generating a pedobarographic template from said pedobarographic data;
comparing a current pedobarographic template with a plurality of stored reference pedobarographic templates for one or more persons, respectively, each template having a unique identifier;
determining a degree of correlation between the current pedobarographic template and each stored template by determining whether there is a match within a threshold range, if there is a match, returning the unique identifier associated with the reference template, and if there is no match, indicating that there is no match.

80. A method of using pedobarographic data to characterize a person, comprising the steps of:
using pedobarographic sensor means to acquire pedobarographic data from said person,
generating locally from the acquired pedobarographic data a pedobarographic template characterizing the person and correlating said pedobarographic signature template with at least one locally stored reference pedobarographic template associated with either or both of a specified person and an item of apparel; and
characterizing the person according to the degree of correlation between the generated pedobarographic template and the at least one locally stored reference pedobarographic template.

81. A method according to claim 72, wherein:
the pedobarographic biometric data are acquired from the person at predetermined intervals;
a pedobarographic template is generated periodically from said pedobarographic data,
a newly-generated pedobarographic template is correlated with the stored reference pedobarographic template to determine a degree of correlation,
wherein the determination of a degree of correlation comprises determining whether there is a match within a predetermined threshold range, with an unauthenticated status, and
generating an output signal dependent upon whether or not there is a match,
the pedobarographic biometric data preferably being acquired by acquiring a set of data from each of a plurality (n) of sensors of the sensor means at a plurality (m) of time intervals;
the step of correlating the newly-generated pedobarographic template then optionally comprising the step of processing each acquired set of data to generate a corresponding set of relative differences in pressure data between different pairs of the sensors, adjusting said data to compensate for pressure differences attributable to a change in the weight of the wearer, including articles being carried by the wearer, as compared with the weight of the wearer when the reference pedobarographic template was created and computing a correlation vector therefrom, for example by calculating a standard deviation.

82. A method according to claim 72, wherein the pedobarographic data are acquired for both feet of the wearer and the step of processing the data periodically to create a template processes the pedobarometric data for either, each or both feet.

83. A method according to claim 72, wherein at least a second item of apparel having a second sensor means is used for acquiring biometric data, the step of acquiring biometric data acquires biometric data from both the first and second sensor means and the comparing step correlates each of the first and second sets of biometric data with a corresponding one of first and second previously-stored reference biometric templates for both items of apparel and characterizes the wearer on the basis of both comparisons.

84. A method according to claim 72, wherein at least a second item of apparel having a second sensor means is used for acquiring biometric data, the step of acquiring biometric data acquires biometric data from both the first and second biometric sensor means and the comparing step correlates each of the first and second sets of biometric data with a corresponding one of first and second previously-stored reference biometric templates for both items of apparel and characterizes the wearer on the basis of both comparisons.

85. A method according to claim 84, further comprising the step of recording in each item of apparel an identifier identifying the item as a member of a set comprising both items, subsequently monitoring the identifiers while the items of apparel are being worn, determining whether or not the items as worn are members of the same set and providing an output signal according to whether or not the items are determined to be members of the same set.

86. A method of authenticating or identifying a person currently wearing an item of apparel, for example an item of footwear having a pressure-sensitive sensor means for collecting pedobarographic biometric data, wherein the item of apparel, while being worn by the person, collects current biometric data that is uniquely characteristic of the wearer, the biometric data is compared with corresponding biometric data previously collected via the same item of apparel while worn under controlled conditions, and stored, and the result of the comparison is used to determine whether or not the current wearer is the same person who wore the apparel under said controlled conditions.

87. A method for biometric identification of a person comprising:
monitoring pedobarographic sensor means at predetermined intervals to obtain pedobarographic biometric data of that person;
generating a pedobarographic template from said pedobarographic data;
determining a degree of correlation between a current pedobarographic template and a stored reference pedobarographic template, by steps comprising comparing a current pedobarographic template with a plurality of locally stored reference pedobarographic templates for each of a respective plurality of persons having a unique identifier;
wherein the step of determining a degree of correlation comprises determining whether there is a match within a threshold range, and when there is a match, returning the unique identifier associated with the reference template, and otherwise indicating there is no match.

88. A method for providing at least one of identification and authentication of a person using biometric data comprising: using pedobarographic sensor means for generating biometric data comprising pedobarographic data, locally generating therefrom a pedobarographic signature and correlating said pedobarographic signature with at least one locally stored reference pedobarographic signature, each associated with a unique identifier of a respective person.

89. A method for real time biometric authentication of a person comprising:
monitoring pedobarographic sensor means to obtain pedobarographic biometric data from the person at predetermined intervals, said pedobarographic sensor means being associated with a unique identifier;
periodically generating a pedobarographic template from said pedobarographic data;
determining a degree of correlation between the stored template and newly generated template by steps comprising comparing a newly generated pedobarographic template with a stored (reference) pedobarographic template, wherein determining a degree of correlation comprises determining whether there is a match within a threshold range, a match being associated with an authenticated status and no match being associated with an unauthenticated status; and
generating an output signal dependent on the degree of correlation to provide an indication of authentication status.

90. A method according to claim 86, further comprising an enrollment step of locally creating a profile for the person, the profile comprising a unique identifier registered to the person, locally stored identity information about the person, and at least one pedobarographic reference template generated for said person and stored in association with said unique identifier.

91. A method according to claim 90, wherein generating a pedobarographic template comprises: acquiring a set of data from each of a plurality of (n) sensors of the pedobarographic sensor means at a plurality of (m) time intervals, and optionally processing acquired biometric data to generate a corresponding set of relative differences in pressure data between sensors, normalizing the data to compensate for weight changes of the individual, preferably computing a correlation vector therefrom, for example by calculating a standard deviation matrix, and, where the item of apparel is an item of footwear, optionally collecting and processing pedobarographic data using pressure-sensitive sensor means in items of footwear for both feet.

92. A method according to claim 86, wherein, in use, the set of apparel generates a signal indicative of integrity of the set of apparel, the method further comprising monitoring for said integrity signal and, dependent on the signal indicative of integrity of the set of apparel, providing said output signal to indicate authentication status accordingly.

93. A method according to claim 72, wherein said item of apparel comprises one of a pair of right and left items of footwear having right foot sensors and left foot sensors, respectively, and the local processing means captures data from both right foot sensors and left foot sensors, derives a right foot template and a left foot template, correlates the right foot template and left foot template with locally_stored right foot and left foot reference templates, respectively, and determines said match in dependence upon the degree of correlation of the data from both the right foot and the left foot, the determination of the match optionally taking into account each degree of correlation in relation to predetermined threshold values of correlation, defining, for example, lower, middle and upper ranges of degrees of correlation.

94. A method for identification of an alarming event comprising:
monitoring pedobarographic sensor means to obtain pedobarographic biometric data of at least one person;
generating a current pedobarographic template for each person from said pedobarographic data;
determining a degree of correlation between a current pedobarographic template and a plurality of stored reference pedobarographic templates that were generated under alarming conditions, by comparing the current pedobarographic template with the plurality of stored reference pedobarographic templates that represent alarming conditions for each person;
wherein the step of determining a degree of correlation comprises determining whether there is a match within a threshold range, and when there is a match, indicating that an alarming event has occurred.

95. A system for characterizing a wearer of an item of apparel, the system comprising:
sensor means in or associated with the item for sensing at least one biometric characteristic of a wearer of the item,
storage means in or associated with said item for storing biometric data, and
processor means in or associated with said item of apparel for controlling the sensor means to acquire biometric data from the wearer, compare the acquired biometric data with corresponding biometric data for a specified wearer, preferably previously collected via the same or a similar item of apparel while worn by the specified wearer under controlled conditions, characterizing the wearer in dependence upon the results of the comparison according to prescribed criteria, and for outputting a signal indicative of the result of the characterization,
the processing means optionally generating from said biometric data a pedobarographic template, and
correlating said pedobarographic template with at least one stored reference pedobarographic template associated with a unique identifier of a respective person.

96. A system for providing at least one of identification and authentication of a person using pedobarographic data comprising:
pedobarographic sensor means for generating biometric data,
local processing means for generating a pedobarographic template and preferably storing the pedobarographic template on the person, for example in said item of apparel, and
local means for correlating said pedobarographic template with at least one locally stored reference pedobarographic template associated with a unique identifier of a specified person.

97. A system comprising sensor means in or for association with an item of apparel for capturing data about at least one biometric characteristic of a person wearing the item of apparel, for example pedobarographic data, gait-based biometric data, including gait information and/or walking cadence, or other kinetic data, the item of apparel comprising storage means for securely storing said data, and processing means for correlating data captured in a first time interval during wearing of the item of apparel by a registered authorized user, and data captured during a subsequent time interval, and determining whether or not there is a match of said data, a mismatch being indicative of wearing of the apparel by an unauthorized user,
the system optionally further comprising means for annunciating whether or not the current wearer is an unauthorized wearer,
the processing means preferably providing for real time processing of data captured and stored periodically during use.

98. A system according to claim 97, wherein said apparel comprises right and left footwear having right foot sensors and left foot sensors, respectively, and the processing means captures data from both right foot sensors and left foot sensors, derives a right foot template and a left foot template, correlates the right foot template and left foot template with stored right foot and left foot reference templates, respectively, and determines said match in dependence upon the degree of correlation of the data from both the right foot and the left foot,
each degree of correlation optionally being determined in relation to predetermined threshold values of correlation, defining, for example, lower, middle and upper ranges of degrees of correlation.

99. Biometric security apparatus for providing for at least one of monitoring, identification and authentication of a person, comprising:
pedobarographic sensor means for acquiring pedobarographic data of said person and having associated identity information comprising at least a unique identifier tag;
control means comprising:
input means for receiving data from said pedobarographic sensor means, and
local_storage means for storing data comprising at least one pedobarographic template (signature) generated from said pedobarographic data, and associated identity information;
local processing means operable to:
monitor/sample pedobarographic data from the pedobarographic sensor means at predetermined intervals and periodically generate a current pedobarographic template (signature) therefrom; and
compare a current pedobarographic template (current template) with a stored reference pedobarographic template (stored template), and determine a degree of correlation between the current template and the stored reference template; and
output means for generating an output/control signal dependent on the degree of correlation between the stored reference template and the current template,
said correlation means optionally providing an output control signal indicative of an authentication status, for example when a degree of correlation between a current template and the stored template is within a threshold range; otherwise said output signal being indicative of an unauthenticated status,
or said correlation means optionally providing an output control signal indicative of an alarm status, for example when a degree of correlation between a current status template and an alarm template is within a threshold range.

100. Biometric security apparatus according to claim 99, wherein the processing means comprises means for encrypting data whether being input, output or stored.

101. Biometric security apparatus according to claim 99, further comprising annunciation means for annunciating an authentication status dependent on said output control signal, for example, wherein the annunciator means comprises one or more of visual display means, audible signal generation means, inaudible signal generating means and RF transponder means.

102. Biometric security apparatus according to claim 99, wherein the pedobarographic sensor means comprises a plurality of sensors of a pedobarographic insole for footwear, and said control means is connected thereto.

103. Biometric security apparatus according to claim 99, associated with a pair of footwear, wherein the pedobarographic sensor means comprises a plurality of sensors embedded in at least a sole portion of each of the footwear, and wherein the control means is carried by at least one of the pair of footwear.

104. Biometric security apparatus according to claim 99, associated with a pair of footwear, wherein the pedobarographic sensor means comprises a set of a plurality of sensors in a sole portion of each of the pair the footwear, and control means are carried by each of the pair of footwear, one of the pair carrying a first storage and processing means and the other one of the pair providing second storage and processing means, and further comprising interface means for connecting said first and second control means, for example, wherein the first control means functions as a master and the second control means functions as a slave.

105. Biometric security apparatus according to claim 101, wherein an annunciating means is provided on at least one of the pair of footwear for indicating authentication status dependent on control signal received from at least one of said pair of footwear.

106. Biometric security apparatus according to claim 104, wherein said footwear comprises part of a set of apparel, for example a uniform, comprising said pair of footwear and at least one other item of apparel, each item carrying a unique identifier tag, at least one interface means for connection with footwear or other apparel of the set, and a communications gateway for sending/receiving data from said at least one connection.

107. Biometric security apparatus according to claim 99, associated with a pair of footwear, wherein the pedobarographic sensor means comprises a set of a plurality of sensors in a sole portion of each of the pair the footwear, and first and second control means are carried by respective ones of the pair of footwear, one of the pair carrying a first storage and processing means and the other one of the pair providing second storage and processing means, and further comprising interface means for connecting said control means, for example, wherein the first control means functions as a master and the second control means functions as a slave, wherein said footwear may comprise part of a set of apparel, for example a uniform, comprising said pair of footwear and at least one other item of apparel, each item carrying a unique identifier tag, at least one interface means for connection with footwear or other apparel of the set, and a communications gateway for sending/receiving data from said at least one connection.
wherein said connection means preferably comprises a connector interface on each one of the pair of footwear for connection to other items of apparel
and optionally control means of a right one and a left one of the pair of footwear is connected by the connecting means via at least one other item of apparel,
the means for connecting comprising, for example, wired connections carried by the footwear and other items of apparel, including fiber optic connections, or wireless connections therebetween.

108. Biometric security apparatus according to claim 106, wherein said communications gateway comprises part of the control means.

109. Biometric security apparatus according to claim 108, further comprising annunciation means carried by at least one of said set of apparel for indicating an authentication status dependent on a control signal received from the control means.

110. Biometric security apparatus according to claim 108, wherein the control means monitors integrity of connections between said set of apparel, and generates an output control signal indicative of integrity status.

111. Biometric security apparatus using the method according to claim 72, wherein said pedobarographic sensor means is tagged with a unique identifier associated with a registered owner thereof, and said unique identifier tag of each of said at least one other item of apparel is associated with the registered owner thereof.

112. Biometric security apparatus according to claim 99, wherein the control means provides for enrollment of a registered user of the apparatus, comprising receiving and storing identity information of the registered user, and generating and storing at least one initial reference pedobarographic template of the registered user.

113. Biometric security apparatus according to claim 99, further comprising: means for querying a database comprising a plurality of stored (reference) pedobarographic templates for each of a respective plurality of persons associated with a respective unique identifier, and determining whether there is a match with the current template within a threshold range, and when there is a match, returning the unique identifier associated with the matched reference template, and otherwise indicating there is no match.

114. Biometric security apparatus according to claim 99, wherein the processing means further comprises means for encryption of data and communications comprising pedobarographic templates and identity information.

115. A set of apparel comprising a plurality of items normally worn together, each item having means for registering the item as a member of the set, and means for detecting whether or not one or more of said items are being worn at the same time as another item that is not a member of the set, and signaling if said another item is not a member of the set.
